(19) United States
(12) Patent Application Publication
(10) Pub. No.: US 2025/0289207 A1
(43) Pub. Date: Sep. 18, 2025

(54) SOLAR-CONTROL STRUCTURE WITH IMPROVED ADHESION

(71) Applicant: 3E NANO INC., TORONTO (CA)

(72) Inventors: NAZIR PYARALI KHERANI, TORONTO (CA); NAVID SOHEILNIA, RICHMOND HILL (CA); GOVIND NANDA, TORONTO (CA); MOEIN SHAYEGANNIA, TORONTO (CA); DAVID P. MAIKOWSKI, PLYMOUTH, MI (US); JOSE NUNEZ-REGUEIRO, ANN ARBOR, MI (US); ALEXEY KRASNOV, CANTON, MI (US)

(21) Appl. No.: 19/078,390

(22) Filed: Mar. 13, 2025

Related U.S. Application Data
(60) Provisional application No. 63/565,180, filed on Mar. 14, 2024.

(51) Int. Cl. B32B 17/10

(52) U.S. Cl. CPC B32B 17/10201; B32B 17/10651; B32B 2307/204; B32B 2307/418; B32B 2307/7376; B32B 2311/16; B32B 2311/18; B32B 2311/20; B32B 2311/24

(57) ABSTRACT

The insertion of an ultra-thin sublayer of intentionally oxygen-doped aluminum nitride can drastically improve the adhesion between an intentionally stoichiometrically deposited aluminum nitride and a silver functional layer of a low-emissivity solar-control structure. A similar sublayer, optionally disposed above the functional layer, can improve the adhesion between the silver and top layers of the structure. Additional benefits of inserting the aluminum-oxy-nitride include an improved smoothness of the interface, reduced electron scattering, and better performance of the structure in both visible and infrared spectral regions.

### FIELD

The present invention relates to low-emissivity (low-E) solar-control (LESC) structures and, particularly, to low-E structures with enhanced infrared (IR) reflective silver (Ag) functional electrically conductive layers having improved mechanical adhesion and methods of fabrication of such LESC structures thereof.

### BACKGROUND

Low-emissivity solar-control structures are known in art and are widely employed in various applications such as energy-efficient architectural and automotive glazing. The main characteristics of a LESC structure are its low emissivity (high mid-IR reflectivity) and near-IR control. Emissivity is a unitless surface characteristic representing the total amount of radiant energy emitted by a surface in relation to that by an ideal black body surface, both surfaces being at the same temperature—and as such a critical property that can be utilized to minimize the transfer of ambient thermal energy through the glazing. Solar control characteristics of architectural and automotive glazing are represented by various parameters. The solar heat gain coefficient (SHGC), also known as the g-value or the total solar energy transmittance (TST, TSET or TTS), is the fraction of the impinging total solar radiation transmitted through the glazing (including re-radiation of the energy absorbed in the glazing). Another important characteristic of solar-control heat-insulating glazing is its visible light transmittance (Tvis or VLT). The Tvis to SHGC ratio is called light-to-solar heat gain (LSG) ratio. The higher the LSG, the more daylight a glazing can deliver while transferring less solar heat, thus impacting occupant comfort.

To maximize the LSG, large-area LESC coatings are typically deposited by magnetron sputtering and comprise at least one highly electrically conductive and optically transparent functional metal layer, such as silver. Properly deposited silver offers optimal values of index of refraction (IOR) and extinction coefficient in the visible spectral range and in the infrared. To achieve the above-mentioned optical and electrical properties optimally, it is essential to deposit the Ag functional layer with a <111> crystal orientation, achieve a smooth interface with the underlying bottom layer, and realize a well-developed crystalline grain structure to minimize scattering of free electrons. Additional important requirements include the high purity of the silver sputter deposition process as well as proper selection of the so-called wetting layer. The former primarily implies a lack of oxygen contamination in the argon-based plasma used for deposition of the silver layer. Further, the use of a material with a <002> crystal orientation in the wetting layer is preferred, which is known to promote the growth of <111>-oriented silver.

<002>-Oriented doped zinc oxide (ZnOx) has traditionally been used by various coated glass manufacturers as a wetting layer of choice for depositing silver functional layers in LESC coatings. However, doped ZnOx is known to have insufficient blocking properties against the unwanted migration of alkaline elements from the glass substrate, especially during glass tempering, hot-bending glass process, or post-deposition activation, thus requiring the use of at least one additional alkaline-blocking layer. The requirement of such an additional layer from the perspective of optical design calls for it to have a high index of refraction. This narrows down the choice of the blocking layer to a high-index silicon nitride (Si₃N₄) or a high-index silicon-oxy-nitride (SiOxNy) with a high nitrogen content. Both options are known to present adhesion problems at the interface between the LESC stack and a glass or plastic substrate due to high residual stress in Si-based layers with high nitrogen content. On top of the silver functional layer, other layers of the stack are deposited, including a corrosion-resistant blocker layer, color-control dielectric layer, and a top protection layer or layer stack.

Quite recently, new types of LESC structures employing a silver layer sandwiched between two aluminum nitride (AlN) layers have been explored. AlN provides effective functionality as a wetting and barrier layer when deposited below the Ag functional layer as well as a blocker layer when deposited on top of it. Further improvements in the performance of LESC structures were achieved by hydrogenating both bottom and top AlN layers (AlN:H).

Similar to ZnOx, AlN has a <002> orientation and promotes the growth of the <111>-oriented silver functional layer. This ensures, among other characteristics, high optical transmittance in the visible and high reflectance in the IR spectral range, thus maximizing the LSG of the coated glazing. The drawback of using AlN alone as a wetting layer is its compromised chemical adhesion to the Ag layer due to the weak electron interaction between the two materials.

Coincidently, insufficient adhesion was also observed by the inventors of the present invention at the Ag/AlN interface. It would be desirable, therefore, to provide an AlN-based thin-film LESC design which enables, in addition to high optical and electrical performance of a silver functional layer, its superior adhesion properties for the interfaces between silver and both top and bottom AlN.

### SUMMARY

In an embodiment, the present invention discloses a method for making a low-emissivity solar-control structure by modifying the AlN wetting layer in such a way as to having it intentionally doped with oxygen, thus forming an aluminum oxynitride (AlOxNy) sublayer in direct contact with the Ag functional layer.

The bulk of the wetting layer is denoted as AlN and, although is not intentionally doped, may unintentionally be contaminated with some oxygen during the deposition process. Its thickness ranges between 10 and 90 nm. The thickness of the AlOxNy sublayer must have a minimum “critical mass density (per unit area)” (or, in other words, a sufficient thickness) to ensure enhanced chemical and mechanical bonding with Ag, thus enabling improved adhesion. The larger crystallographic lattice constants (along the c-axis) of amorphous aluminum oxide (Al₂O₃) and crystalline AlN are respectively 1.3 and 0.5 nm. It was surprisingly found by the inventors of the present invention that between 3 and 7 nm (or an equivalent of AlOxNy thickness representing about 3-5 lattice constants, depending on oxygen content) is necessary to enable sufficient engagement of the silver layer in strong chemical bonding with the silver wetting layer.

The AlOxNy layer can be viewed as a surface/interface compound where said range of physical thickness enables requisite covalent bonding on both the AlN side and the Ag side. Interface layers of thickness less than the equivalent of three (3) lattice constants can still provide enhanced bonding, however at a proportionately lower level considering the lack of well-developed uniform surface compound properties.

The oxygen-free deposition of the bulk region of the AlN wetting layer, notwithstanding occasional inclusion of small amount of residual oxygen due to the base-vacuum background partial pressure of oxygen during the synthesis of nominal stoichiometric aluminum nitride, is essential for the following three primary reasons. Firstly, it ensures the superior barrier properties of the monolayer against the diffusion of alkaline species, such as sodium, from the glass substrate, especially at high post-deposition processing temperatures. Such barrier properties allow to avoid the use of an additional barrier dielectric layer, such as SiO₂, SiOxNy, or Si₃N₄, which are known to have a low deposition rate, are susceptible to a high residual stress, and typically require more than one sputtering target in production, which adds to the manufacturing cost. Secondly, depositing a thick (more than 5 nm) quality layer of AlOxNy with a substantial oxygen content in production environment is known to be quite challenging due to a) the high reactivity of oxygen leading to “poisoning” of aluminum sputtering targets caused by the formation of insulating oxide islands and b) an ill-defined “hysteresis” or poor process controllability due to a so-called floating working point, at which the sputtering is relatively stable. As a result, the thicker the AlOxNy layer, the more difficult it is to control its stoichiometry in the manufacturing environment. Thirdly, aluminum nitride has a relatively high index of refraction (IOR), around 2.2 at 550 nm. “Diluting” AlN with oxygen in an AlOxNy compound, depending on the oxygen content, can lower the IOR down to as low as that of pure aluminum oxide, i.e., 1.7. This in turn compromises the anti-reflective optical properties of the thin-film LESC structure, which adds to increased optical losses and poorer thermal performance.

As discovered by the inventors of the present invention, the intentional addition of oxygen to the interfacial region of the wetting layer which is in direct contact with silver advantageously results in drastically improved adhesion between the silver functional layer and the wetting bilayer as compared to the adhesion between Ag and an essentially oxygen-free AlN. On the one hand, the explanation of the improved adhesion lies in the differences in the electronegativity between oxygen, silver, and aluminum. Electronegativity represents the ability of an element to attract shared pair of bonding electrons towards itself (the higher the value the higher the attraction). The electronegativity of Ag and Al are respectively 1.93 and 1.61 on the Pauling Scale, which indicates the relatively weak bonding between the silver functional layer and AlN due to a small bonding force created by the shared electrons. When the intentionally oxygen-doped interfacial region of the bilayer is introduced, its oxygen atoms having electronegativity of 3.44 (greater than that of nitrogen at 3.04) serve to effectively attract electrons from both Ag and Al, thus substantially strengthening the chemical bonding and, consequently, enhancing the overall adhesion. The interfacial region, therefore, acts as a “glue” layer between the functional and wetting layers.

On the other hand, adding oxygen contributes to the improved adhesion by promoting the formation of a transitional nano-layer of AgO or Ag₂O—the two most stable phases comprising Ag and O. This is understood by considering the standard enthalpy of formation which represents enthalpy changes (measure of the energy released or consumed) resulting from the formation of one mole of a substance from its constituent elements in their standard states. For comparison, the standard enthalpies of formation of Ag₃N and AgO are respectively +314.4 (endothermic) and −31.1 (exothermic) KJ/mol, indicating that energetically it is far more favorable for the system to form a transitioning layer of silver oxide than a layer of silver nitride, thus explaining the essential role of oxygen in improved bonding between the layers.

It is noteworthy that the ZnOx wetting layer, traditionally used in prior art, inherently comprises oxygen. Its bombardment by energetic sputtering plasma species during the Ag deposition dislodges some oxygen atoms and makes them available to chemically react with silver, thus resulting in the minute oxidation of the silver functional layer during the initial stages of its formation. In the case of a pure AlN wetting layer, such a transitional layer is missing, and a weakly interacting pair of layers is formed, thus resulting in compromised adhesion. The introduction of the AlOxNy interfacial region, therefore, provides controllable means of deliberately adding small amounts of oxygen to the interface with Ag without contaminating the silver and AlN deposition chambers with oxygen.

The improved chemical adhesion within the stack would be greatly welcomed by architectural coated glass manufacturers, especially in the applications requiring to endure tempering and high-temperature post-deposition activation steps of making low-E solar-control coatings. It would also be welcomed in the applications requiring some degree of bendability, such as those using roll-to-roll deposited LESC coatings on polymeric substrates, e.g., those manufactured for energy-efficient window applications. In automotive glazing, improved adhesion of LESC coatings is a prerequisite for good glazing bendability and passenger safety in case of glazing breakage. Further, the application of these well-adhered coatings on polymeric sheets for lighter-weight resilient glazing applications would also be made possible.

The introduction of the AlOxNy region to the wetting layer also promotes energetically favored coalescence of the silver atoms during the early stages of the growth of the functional layer. This in turn makes the bottom Ag interface smoother, more homogeneous, with fewer isolated silver islands, and promotes the silver <111> crystal orientation with a reduced percolation thickness limit—the point at which silver develops a continuous layer. As a result, the thin-film structure comprising the new wetting layer coupled with the Ag functional layer is characterized by reduced electron scattering, which consequently translates to a higher electrical conductivity as well as a higher LSG value.

Similar conclusions are also applicable for the replacement of the pure AlN layer above the silver with an analogous layer having a thin AlOxNy interfacial region directly in contact with the Ag functional layer.

In an embodiment, an additional high-IOR dielectric layer is added below the wetting bilayer to further enhance the antireflective properties of the LESC structure.

In an embodiment, the synthesis of the AlOxNy ultrathin interfacial region of the wetting layer is achieved by deliberately introducing oxygen in the sputtering chamber where said region is deposited via a reactive sputtering process. Gas flow patterns can further be configured to achieve uniform oxygen concentration (in the plasma) laterally and longitudinally (direction of substrate transport) and thus the uniformity in oxygen composition laterally and longitudinally in the layer.

In another embodiment, the gas flow patterns are configured to achieve uniform oxygen concentration laterally but graded oxygen concentration longitudinally; for example, the oxygen concentration can be graded such that it increases in the direction of substrate transport and thus gives rise to increasing oxygen content in the layer along the direction of layer growth which in turn creates a functionally graded transition AlOxNy region in direct contact with the Ag functional layer. This process would be effectively reversed for the bilayer deposited on top of the silver.

In another embodiment, the synthesis of the AlOxNy region is achieved by exposing the AlN layer to a defined oxygen plasma chamber, appropriately situated before the Ag sputter deposition chamber. The gas chemistry of the oxygen plasma chamber can comprise pure oxygen, oxygen-argon mixtures, oxygen-nitrogen-argon mixture, or a mixture of argon with nitrous oxide. Additionally, other inert gases such as helium can also be used to alter plasma conditions and thus effect desired oxidation of the upper regions of the first sublayer of the wetting bilayer.

In another embodiment, the deposition of the AlOxNy region is achieved by sputtering of a ceramic AlOxNy target, or AlN target, using a range of possible sputter gases such as argon, argon-nitrogen, argon-oxygen, or argon-nitrogen-oxygen mixtures, appropriately tuned to achieve the desired stoichiometry, in relation to the stoichiometry of the target material, thus providing for optimal interfacial and layer stack properties.

In embodiments of the invention, the thickness of the AlN region of the wetting layer ranges between 10 and 90 nm and preferably between 20 and 50 nm. The thickness of the AlOxNy region is between 3 and 7 nm and preferably between 4 and 5 nm.

In embodiments of the invention, the ‘x’ in the AlOxNy region is between 0.01 and 1, preferably between 0.05 and 0.5. Accordingly, the ‘y’ ranges between 0.8 and 0.995.

In embodiments the ‘x’ in the AlOxNy formula preferably ranges between 0.9 and 1. It will be appreciated that when ‘x’ is specified, ‘y’ is automatically determined other than in embodiments where non-stoichiometric compounds are preferred.

In embodiments, the anti-reflection layer below the wetting layer is preferentially made of at least one material from the following list: TiO₂, Nb₂O₅, SiOxNy (with ‘x’ ranging between 0 and 0.4 and ‘y’—between 0.6 and 1), or TiSiO₄, each with an index of refraction of at least 1.8 at 550 nm, and a thickness between 5 and 50 nm, preferably between 10 and 30 nm.

In summary, the <002> orientation of the AlN along with the introduction of an ultra-thin oxygen-containing AlOxNy interfacial region, together provide an improved wetting layer that promotes enhanced chemical bonding, preferential growth of <111> Ag, and excellent morphological crystalline interlocking, and thus greatly improved overall adhesion. Additionally, the AlOxNy region enables a higher electrical conductivity of the silver functional layer due to an improved quality of the interface, thus enabling an improved LSG value. Enhanced anti-reflection properties of the LESC stack are further achieved with an additional optional high-IOR dielectric layer deposited below the wetting bilayer. Further adhesion improvements are possible with the replacement of top AlN layer above the Ag functional layer with an AlN layer having an interfacial intentionally oxygen-doped AlOxNy region immediately adjacent to the functional layer.

A further understanding of the functional and advantageous aspects of the disclosure can be realized by reference to the following detailed description and drawings.

### BRIEF DESCRIPTION OF THE DRAWINGS

The present invention can be understood by considering the following drawings and the legend for the reference numerals presented further below:

FIG. 1A is a vertical cross section of a PRIOR ART monolithic low-E solar-control coating architecture used, e.g., in ambient air window inserts (where the coating is exposed to the air) or as part of an insulating glass unit (the coating is exposed to the interior gaseous environment of a window, usually filled with argon), see U.S. Pat. No. 5,737,885 A.

FIG. 1B is a vertical cross section of a PRIOR ART low-E solar-control coating laminated between two substrates with a thermoplastic bonding layer, see U.S. Pat. No. 11,618,507 B2.

FIG. 1C is a vertical cross section of a PRIOR ART example of a window insert with the monolithic LESC coating of FIG. 1A, see U.S. Pat. No. 11,008,800 B2.

FIG. 2 is a vertical cross section of a PRIOR ART traditional low-E solar-control thin-film stack, see US20030180547A1.

FIG. 3A is a vertical cross section of an exemplary LESC structure according to the present disclosure with an AlN wetting layer and an AlN top layer, each having an interfacial AlOxNy region in direct contact with the Ag functional layer.

FIG. 3B is a vertical cross section of an exemplary LESC structure of FIG. 3A, also having an additional color-control layer.

FIG. 3C is a vertical cross section of an exemplary LESC structure with an AlN/AlOxNy wetting layer only.

FIG. 3D is a vertical cross section of the exemplary LESC structure of FIG. 3C but with an additional color-control layer.

FIG. 4 is a photograph Illustrating enhanced adhesion in a LESC structure with top and bottom aluminum nitride dielectric layers having significant oxygen presence proximal to the respective interfaces with the functional silver layer. (a) Sample 3EN-46: Layer stack without the presence of significant oxygen concentration. Adhesion rating of GT 2. (b) Sample 3EN-61: Layer stack with the presence of significant oxygen concentration. Adhesion rating of GT 0. Cross-hatch adhesion tests per ASTM3359.

### DEFINITION OF THE REFERENCE NUMERALS IN THE DRAWINGS

100, 200, 300 Substrate (pane 1)
110, 210, 310 LESC coating
111 Monolithic LESC coated structure (the glazing insert)
120 Thermoplastic bonding layer
130 Protective pane (pane 2)
131 Main glazing of a window
132 Main window frame
133 Secondary frame for the monolithic coated glazing insert
220 Barrier layer against the diffusion of alkaline elements
230 Foundation layer
240 Traditional wetting layer
250, 350 Ag functional layer
260, 360 Blocker layer
270, 370 Color-control layer
280, 380 Protection layer
325 AlN region, not intentionally doped with oxygen, of the wetting bilayer
335 AlN region, not intentionally doped with oxygen, of the layer directly above the Ag functional layer
345 AlOxNy interfacial region, intentionally doped with oxygen, of the wetting layer
365 AlOxNy interfacial region, intentionally doped with oxygen, of the top layer directly above the Ag functional layer
390 AR layer

### DETAILED DESCRIPTION

A detailed description is provided below to facilitate a thorough understanding of the disclosed embodiments and connections thereof. The description is not limited to any particular example included herein.

Various embodiments and aspects of the disclosure will be described with reference to the details discussed below. The following description and drawings are illustrative of the disclosure and are not to be construed as limiting the disclosure. Numerous specific details are described to provide a thorough understanding of various embodiments of the present disclosure. The Figures are not to scale. However, in certain instances, well-known or conventional details are not described in order to provide a concise discussion of embodiments of the present disclosure.

As used herein, the terms, “comprises” and “comprising” are to be construed as being inclusive and open ended, and not exclusive. Specifically, when used in the specification and claims, the terms, “comprises” and “comprising” and variations thereof mean the specified features, steps or components are included. These terms are not to be interpreted to exclude the presence of other features, steps or components.

As used herein, the term “exemplary” means “serving as an example, instance, or illustration,” and should not be construed as preferred or advantageous over other configurations disclosed herein.

As used herein, the terms “about” and “approximately”, when used in conjunction with ranges of dimensions of particles, compositions of mixtures or other physical properties or characteristics, are meant to cover slight variations that may exist in the upper and lower limits of the ranges of dimensions so as to not exclude embodiments where on average most of the dimensions are satisfied but where statistically dimensions may exist outside this region. It is not the intention to exclude embodiments such as these from the present disclosure. Unless otherwise specified, the terms “about” and “approximately” mean plus or minus 25 percent or less.

It is to be understood that unless otherwise specified, any specified range or group is as a shorthand way of referring to each and every member of a range or group individually, as well as each and every possible sub-range or sub-group encompassed therein and similarly with respect to any sub-ranges or sub-groups therein. Unless otherwise specified, the present disclosure relates to and explicitly incorporates each and every specific member and combination of sub-ranges or sub-groups.

As used herein, the term “on the order of”, when used in conjunction with a quantity or parameter, refers to a range spanning approximately one tenth to ten times the stated quantity or parameter.

In some embodiments, the present invention discloses methods of making low-emissivity solar-control coatings with improved adhesion and coated articles based on said methods. In some embodiments, a LESC coating is made by sputter depositing at least one bilayer comprising two sublayers—one not intentionally doped with oxygen and the other one intentionally doped with oxygen—from at least one side of a Ag functional layer for forming a LESC structure with improved adhesion between said at least one bilayer and the Ag functional layer.

In some embodiments, at least one said bilayer not only improves adhesion but is also beneficial for reducing the roughness of its interface with the Ag functional layer.

In some embodiments, said bilayer, when used as wetting layer, improves crystal orientation of the Ag functional layer and reduces its percolation thickness at which point silver atoms begin to coalesce in a continuous layer during the layer growth. This in turn results in improved visible transmittance as well as increased reflectance in the near-IR.

In some embodiments, the present invention discloses methods for making low-E coatings with improved adhesion and enhanced spectral properties in both visible and infrared spectral regions by introducing an ultra-thin interfacial AlOxNy region, intentionally doped with oxygen, between the AlN, not intentionally doped with oxygen (such as stoichiometric AlN), and the silver functional layer.

The oxygen-free deposition of the bulk region of the AlN wetting layer, notwithstanding occasional inclusion of small amount of residual oxygen due to the base-vacuum background partial pressure of oxygen during the synthesis of nominal stoichiometric aluminum nitride, is essential for the following three primary reasons. Firstly, it ensures the superior barrier properties of the monolayer against the diffusion of alkaline species, such as sodium, from the glass substrate, especially at high post-deposition processing temperatures. Such barrier properties allow to avoid the use of an additional barrier dielectric layer, such as SiOx, SiOxNy, or SiNx, which are known to have a low deposition rate, are susceptible to a high residual stress, and typically require more than one sputtering target in production, which adds to the manufacturing cost. Secondly, depositing a thick (more than 5 nm) quality layer of AlOxNy with a substantial oxygen content in production environment is known to be quite challenging due to a) the high reactivity of oxygen leading to “poisoning” of aluminum sputtering targets caused by the formation of insulating oxide islands and b) an ill-defined “hysteresis” or poor process controllability due to a so-called floating working point, at which the sputtering is relatively stable. As a result, the thicker the AlOxNy layer, the more difficult it is to control its stoichiometry in the manufacturing environment. Thirdly, aluminum nitride has a relatively high index of refraction (IOR), around 2.2 at 550 nm. “Diluting” AlN with oxygen in an AlOxNy compound, depending on the oxygen content, can lower the IOR down to as low as that of pure aluminum oxide, i.e., 1.7. This in turn compromises the anti-reflective optical properties of the thin-film LESC structure, which adds to increased optical losses and poorer thermal performance.

The resultant wetting layer with an elevated oxygen content at the interface with the silver functional layer advantageously leads to drastically improved adhesion between the two layers as compared to the adhesion between Ag and an essentially oxygen-free AlN.

The improved adhesion due to the introduction of an AlOxNy region is attributed to two physical phenomena. The first one can be understood from the difference in the electronegativity between oxygen, silver, and aluminum. Electronegativity represents the ability of an element to attract shared-pair of bonding electrons towards itself. The electronegativity of Ag and Al are respectively 1.93 and 1.61 on the Pauling Scale, which indicates the relatively weak bonding between the silver functional layer and AlN due to a small bonding force created by the shared electrons. When the AlOxNy region is introduced, its oxygen atoms having electronegativity of 3.44 (greater than that of nitrogen at 3.04) serve to attract electrons from both Ag and Al, thus substantially strengthening the chemical bonding and, consequently, enhancing the mechanical adhesion. The AlOxNy region, therefore, acts as a “glue” layer between the functional and wetting layers. The same phenomenon is at the basis of the improved adhesion between the Ag functional layer and the top AlN layer having an interfacial AlOxNy region.

The second phenomenon underlying the improved adhesion between the AlN wetting layer having an interfacial AlOxNy region and the functional layer can be explained by the formation of a AgO or Ag₂O—the two most stable phases comprising Ag and O—nanolayer. This is understood by considering the standard enthalpy of formation which represents enthalpy changes (measure of the energy released or consumed) resulting from the formation of one mole of a substance from its constituent elements in their standard states. For comparison, the standard enthalpies of formation of Ag₃N and AgO are respectively +314.4 and −31.1 KJ/mol, indicating that energetically it is far more favorable for the system to form a transitioning layer of silver oxide than a layer of silver nitride, thus explaining the essential role of oxygen in improved bonding between the layers. In a traditionally used doped ZnOx wetting layer, oxygen is inherently present. Its bombardment by energetic sputtering plasma species during the Ag deposition dislodges some oxygen atoms and makes them available to chemically react with silver, thus resulting in the minute oxidation of the silver functional layer during the initial stages of its formation. In the case of a pure AlN wetting layer, such a transitional layer is missing. The introduction of the AlOxNy region, therefore, provides controllable means of deliberately adding small amounts of oxygen to the interface with Ag without contaminating the Ag and AlN deposition chambers with oxygen.

The improved adhesion within the stack would be highly desirable in architectural coated glass, especially in the applications requiring enduring tempered and high-temperature post-deposition activation steps of making low-E coatings. It would also benefit the applications requiring some degree of bendability, such as those using roll-to-roll deposited LESC coatings on polymeric substrates, e.g., those manufactured for energy-efficient window applications. In automotive glazing, improved adhesion of LESC coatings is a prerequisite for good glazing bendability and passenger safety in case of glazing breakage. Further, the application of these well-adhered coatings on polymeric sheets for lighter-weight resilient planar and bendable glazing applications would be made possible.

The introduction of the AlOxNy region also promotes energetically favored coalescence of the silver atoms during the early stages of the growth of the functional layer. This in turn makes the bottom Ag interface smoother, more homogeneous, with fewer isolated silver islands, and promotes the silver <111> crystal orientation with a reduced percolation thickness limit—the point at which silver develops a continuous layer. As a result, the new thin-film structure comprising an improved AlN wetting layer is characterized by reduced electron scattering in the silver layer, which is subsequently translated to its higher electrical conductivity as well as a higher LSG value.

In an embodiment, only one AlN layer having an interfacial AlOxNy region immediately adjacent to the functional layer is used as a wetting layer.

In an embodiment, only one AlN layer having an interfacial AlOxNy region immediately adjacent to the functional layer is used as a top layer.

In an embodiment, an additional high-IOR dielectric layer is added below the wetting layer to enhance the antireflective properties of the LESC structure.

In an embodiment, an additional color-control layer is disposed.

In embodiments, a protection layer is disposed on the top of the stack.

In an embodiment, the synthesis of the AlOxNy region between the AlN and the silver functional layer is achieved by deliberately introducing oxygen in the sputtering chamber where the AlOxNy is deposited via a reactive sputtering process. Gas flow patterns can further be configured to achieve uniform oxygen concentration (in the plasma) laterally and longitudinally (direction of substrate transport) and thus the uniformity in oxygen composition laterally and longitudinally in the layer.

In another embodiment, the gas flow patterns can be configured to achieve uniform oxygen concentration laterally but graded oxygen concentration longitudinally; for example, the oxygen concentration can be graded such that it increases in the direction of substrate transport and thus gives rise to increasing oxygen content in the layer along the direction of layer growth which in turn creates a functionally graded transition AlOxNy region between the AlN and the Ag functional layer.

In another embodiment, the synthesis of the AlOxNy region is achieved by exposing the AlN to a defined oxygen plasma chamber, appropriately situated between the AlN sputter deposition chamber and Ag sputter deposition chamber. The gas chemistry of the oxygen plasma chamber can comprise of pure oxygen (O₂), argon-oxygen mixtures (Ar+O₂), argon-oxygen-nitrogen mixture (Ar+O₂+N₂), or a mixture of argon with nitrous oxide (Ar+N₂O). Additionally, other inert gases such as helium can also be used to effect desired oxidation of the interfacial region of the AlN.

In another embodiment, the synthesis of the AlOxNy region is achieved by sputtering of a ceramic AlOxNy target, or a ceramic AlN target, with appropriate sputter gas mixtures; example gas mixtures include argon (Ar), argon-oxygen mixtures (Ar+O₂), argon-oxygen-nitrogen mixtures (Ar+O₂+N₂), or a mixture of argon and nitrous oxide (Ar+N₂O).

In embodiments, the architecture of the structure is monolithic, i.e., the LESC layer stack is deposited on a substrate and is exposed to atmosphere, such as to the air in case of window inserts or to argon or other inert gas (krypton, xenon) mixtures or other inert gas—air mixtures in case of encapsulated integrated-glass units.

In embodiments, the structure is laminated to the second pane using a thermoplastic bonding layer.

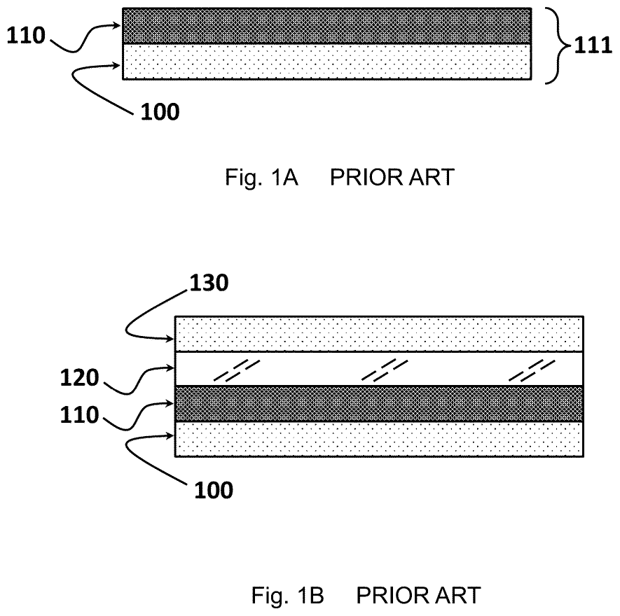

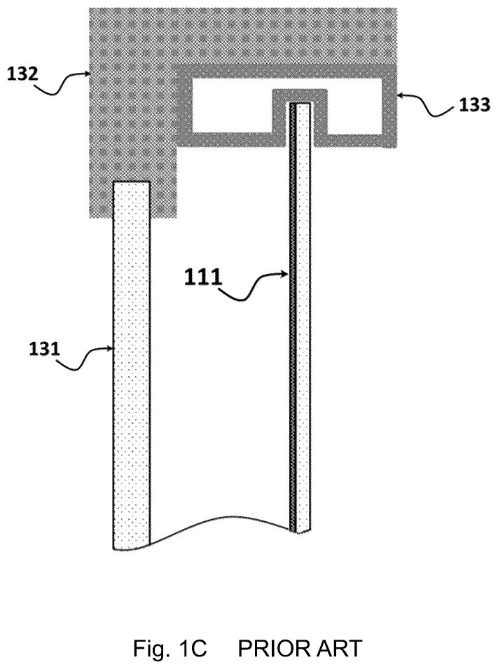

FIG. 1A demonstrates a generic monolithic structure of a low-E solar-control coating deposited on a substantially transparent substrate 100 made from plastic or glass. The structure can be used as-deposited or post-deposition activated by heat or any other source of energy. It can be used in either a monolithic form or as a laminate when bonded with a thermoplastic bonding layer 120 to a second pane 130, as depicted in FIG. 1B.

In a monolithic form, the structure has a LESC coating exposed to the air, such as in a window insert used in addition to the main window glazing, as depicted in FIG. 1C. The use of a plastic substrate in this case is advantageous in lowering the total weight of the combined glazing while improving heat insulation.

The use of a glass substrate, such as that made of soda-lime glass, may be preferred if, for instance, a tempered-glass structure is required for safety reasons. The use of a thin glass substrate is also advantageous in lowering the total weight of the glazing. The laminated structure of FIG. 1B, on the other hand, has a LESC coating secured between the substrate and the second pane. The coating can be used either as-deposited or heat activated, such as during a high-temperature glass bending process, according to some embodiments of the present invention. The use of a laminated structure may also provide the benefit of added safety in case of breakage.

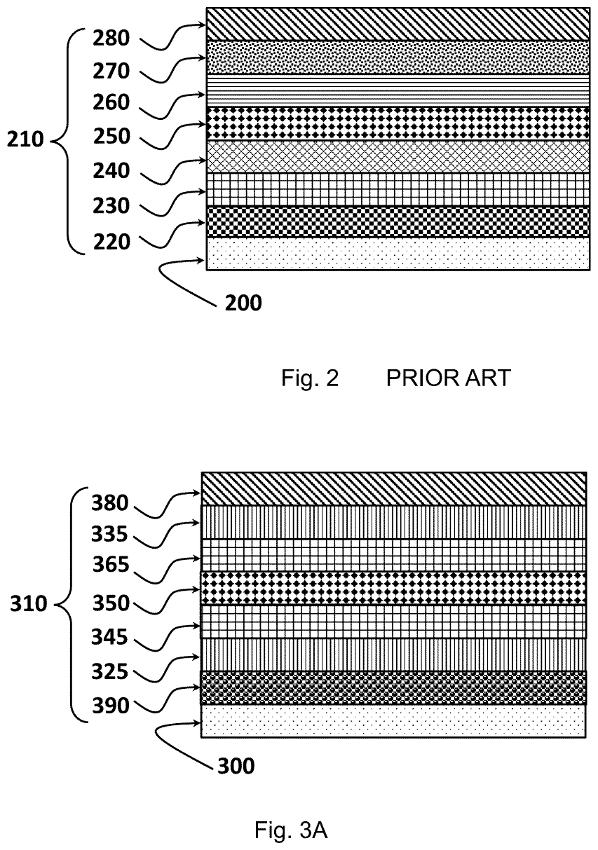

FIG. 2 presents a generic structure comprising a substrate 200 and a traditional low-E solar-control coating 210 consisting of an alkaline-element barrier layer 220 deposited directly on the substrate; a foundation layer 230; a wetting layer 240; a highly electrically conductive and IR reflective Ag functional layer 250; a blocker layer 260; a color-control layer 270; and a protection layer 280. The role of the barrier layer 220 is to prevent the migration of alkaline elements having a high diffusion coefficient, such as sodium, from migrating into the Ag layer and affecting its electro-optical properties. This layer is usually made up of SiNx or SiOxNy with high nitrogen content. The role of the foundation layer 230 is to create a smooth cushion for the wetting layer 240. The foundation layer is typically made up of materials such as TiO₂ or ZnSnO₃. To make the stack work efficiently from the optics point of view, one or both alkaline-element blocking and foundation layers must have a high index of refraction. Si₃N₄ or SiOxNy with high IOR do, unfortunately, exhibit a high level of residual stress which causes poor adhesion between the substrate and the coating. TiO₂, on the other hand, is known to be susceptible to unwanted phase transformations during high-temperature activation; this in turn may compromise its long-term stability.

Pure or doped <002>-oriented ZnO is traditionally used as a wetting layer 240 disposed on top of the foundation layer 230 to achieve the preferred <111> crystal orientation of the Ag functional layer 250. This ensures high levels of LSG due to a high level of silver crystallinity and a smooth interface with ZnO which suppresses scattering of free electrons in the vicinity of the interface between the two layers. To achieve these properties, the purity of the Ag layer during the sputter deposition process must be maintained. The inventors of the present invention discovered that the primary reason for the high quality of the ZnO/Ag interface in traditional low-E solar-control coating designs is the presence of oxygen in the ZnO wetting layer 240.

However, pure or doped ZnO is known to have insufficient blocking properties against the unwanted migration of alkaline elements from the glass substrate, especially during glass tempering, hot-bending glass, or post-deposition activation, thus requiring the use of at least one additional alkaline-blocking layer. The option of using Si₃N₄ or a high-index silicon-oxynitride (SiOxNy) with a high nitrogen content, as mentioned above, often presents adhesion problems at the interface between the low-E solar-control stack with a glass or plastic substrate.

On top of the silver functional layer 250, other layers of the stack are deposited, including a corrosion-resistant blocker layer 260, optional color-control dielectric layer 270, and a top protection layer or layer stack 280. The blocker layer 260 is traditionally made of NiCrOx. Its role is to prevent the Ag layer 250 from corrosion due to the ingress of oxygen atoms from the environment. The optional color-control layer 270 is typically made of zinc-tin-oxide (ZnSnO₃). The protection layer 280 is typically made off any material from the following list: SiO₂, SiOxNy, ZrSiO₄, TiO₂, ZrTiO₄. It will be appreciated that in these layers, the stoichiometry may vary.

A new type of LESC structure employing a silver layer sandwiched between two aluminum nitride (AlN) layers has recently been explored, see CA3061105A. AlN provides effective functionality as both a wetting and an alkaline-blocking layer when deposited below the Ag functional layer as well as a blocker layer when deposited on top of it. Further improvements in the performance of LESC structures were achieved by hydrogenating both bottom and top AlN layers (AlN:H).

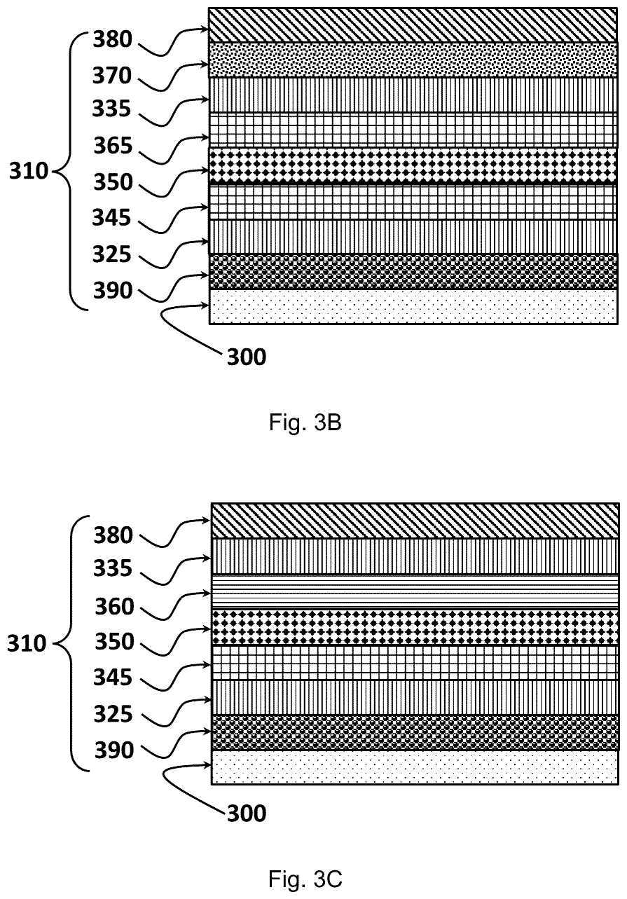

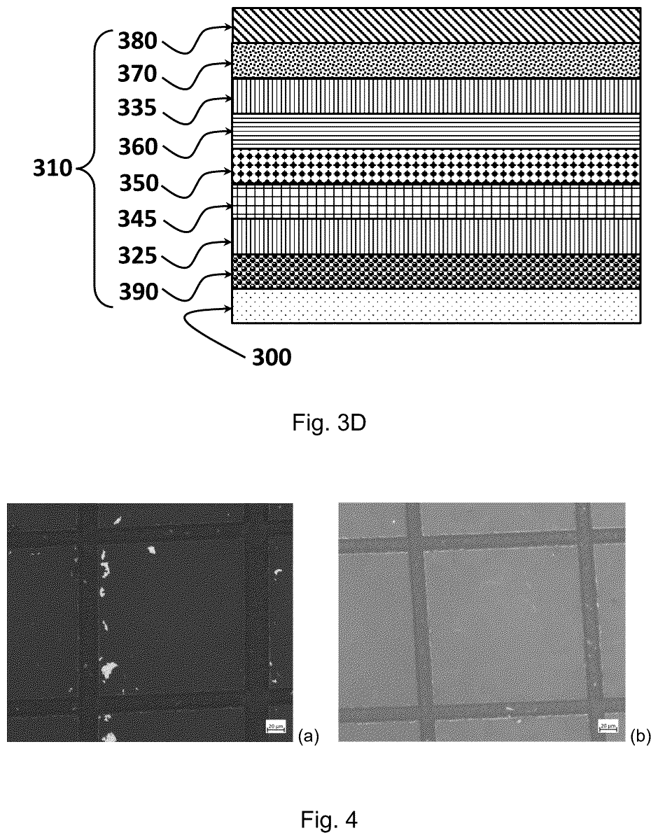

Depicted in FIG. 3A is an exemplified embodiment of the present invention comprising a substrate 300 and a LESC coating 310 comprising a silver functional layer 350 sandwiched between two layers of AlN, each having an interfacial AlOxNy region. The AlN wetting layer has a thickness between about 10 and about 100 nm, and more preferably has a thickness between about 20 and about 50 nm. The solar silver functional layer has a thickness in a range from about 5 nm to about 25 nm.

An additional optional anti-reflection layer 390 is deposited between the wetting bilayer and the substrate 300. The layer is made of a medium—high IOR material, such as TiO₂, Nb₂O₅, SiOxNy, or TiSiO₄ and has a thickness between 5 and 50 nm, preferably 10-30 nm. The layer stack is terminated with a top protection layer 380 made of at least one material from the following list: SiO₂, SiOxNy, ZrSiO₄, TiOx, or ZrTiO₄. Its thickness ranges between 10 and 60 nm, preferably between 15 and 30 nm. Again, it will be appreciated that in these layers, the stoichiometry may vary.

Like ZnOx, AlN has a <002> crystal orientation and promotes the growth of the <111>-oriented silver functional layer. This ensures, among other characteristics, high optical transmittance in the visible and high reflectance in the IR spectral range, thus maximizing the LSG of the coated glazing. The AlN region 325 of the wetting layer below the silver and the AlN region of the top layer immediately above the silver are 10-90 nm, preferably 20-50 nm thick, and are sputter deposited without intentionally adding oxygen to the deposition chamber to respectively ensure the material's high blocking properties to the migration of alkaline elements from the substrate and the oxygen blocking properties. Both AlN regions 325 and 335 can either be undoped or have the presence of intentionally added hydrogen. Hydrogen concentration in said intentionally doped AlN layers is greater than 1000 ppm. The AlOxNy subsurface regions 345 and 365 immediately adjacent to the silver functional surfaces have a thickness between about 3 to about 7 nm, and preferably between 4 and 5 nm thick, on the other hand, are intentionally doped with oxygen. The ‘x’ in the formula for both layers varies between 0.01 and 1 with preferred oxygen content ranging between 0.2 and 0.5. Accordingly, the ‘y’ ranges between 0.5 and 0.8. The oxygen concentration in the subsurface region within the AlN wetting layer immediately adjacent to the bottom surface of the silver functional layer has an oxygen concentration of 0.01 atomic % (at. %) or greater. The oxygen concentration in the regions of the wetting layer that reside outside the subsurface region is less than 0.01 atomic % (at. %).

FIG. 3B depicts an embodiment similar to that of FIG. 3A but with an additional color-control layer 370 disposed between the top AlN layer 335 above the silver and the protection layer 380. The color-control layer is made of at least one material from the following list: ZnSnO₄, TiO₂, Nb₂O₅, ZrO₂, or TiZrO₄, and its thickness ranges between 10 and 80 nm, preferably, between 30 and 70 nm. It will be appreciated that in these layers, the stoichiometry may vary. The physical phenomenon behind the functionality of the color-control layer is optical interference. The transmittance, reflectance, and color of the coating can be tuned (usually to a preferred neutral color) via the material selection and the layer thickness adjustment.

FIG. 3C depicts an embodiment similar to that of FIG. 3A but with only one AlN/AlOxNy combination used as a wetting bilayer disposed below silver. Instead of a similar combination above the silver, an alternative combination of a blocker layer, such as traditional NiCrOx, and a layer of AlN or AlN:H is used in this case. The focus of this embodiment is on improved adhesion between the wetting bilayer and the functional silver layer.

FIG. 3D presents an embodiment similar to that of FIG. 3C but with the addition of the color-control layer 370 below the protection layer 380 made of a material, such as ZnSnO₃, TiO₂, Nb₂O₅, ZrO₂, or TiZrO₄. The thickness of the layer ranges between 10 and 80 nm, preferably between 30 and 70 nm.

FIG. 4 is an Illustration of enhanced adhesion in a LESC structure with top and bottom aluminum nitride dielectric layers having significant oxygen presence proximal to the respective interfaces with the functional silver layer. (a) Sample 3EN-46: Layer stack without the presence of significant oxygen concentration. Adhesion rating of GT 2. (b) Sample 3EN-61: Layer stack with the presence of significant oxygen concentration. Adhesion rating of GT 0. Cross-hatch adhesion tests per ASTM3359.

All individual layers of the thin-film LESC stack 310 can preferably be deposited using one of the following sputtering techniques: direct current, radio frequency, pulsed direct-current, alternate current. Oxide layers can be deposited in a mixture of working gas (argon) and tuning gas (oxygen). Oxynitrides can be deposited in a Ar+O₂+N₂ or Ar+N₂O. Besides, the AlOxNy region can be made by exposing the surface of AlN to oxygen containing plasma. The layers can be deposited using metal or ceramic sputtering targets of various compositions. The targets can be planar, rotatable, or any combination thereof. Other apparatus and additions to the plasma process, such as collimators, electron-confining magnets, or high-power impulse magnetron sputtering may be incorporated. Additional sputter gases, such as He, can be used to alter the plasma characteristics and hence the layer properties.

In embodiments, the present invention discloses an improved substantially transparent structure based on the disclosed LESC coating 310. The present invention also discloses various methods of making the structure, the coating, and individual layers of the coatings. In some embodiments, the visible light transmittance of the structure when measured at 8 degrees off-normal (Tvis(8°)) is greater than 70%.

In embodiments, polymethyl methacrylate (PMMA), 1.0 to 13.0 mm and preferably 1.5-6.0 mm thick, is used as a substrate. The PMMA may be primed with an appropriate hard coating, such as siloxane disposed, e.g., by a gravitational flow or “doctor blade” process.

In embodiments, polycarbonate (PC), 1.0 to 13.0 mm and preferably 1.5-6.0 mm thick, is used as a substrate. The PC may be primed with an appropriate hard coating, such as siloxane disposed, e.g., by a gravitational flow or “doctor blade” process.

In embodiments, the substrate is made of glass, such as soda-lime, borosilicate, alumino-silicate, or any other type of glass including thin-glass with a thickness between 0.5 to 16.0 mm and preferably between 1.5 and 5.0 mm.

In some embodiments, the low-E solar-control coating 310 comprises one Ag functional layer 350. In some embodiments, the coating comprises two or more Ag functional layers, at least one of those layers being in direct contact with at least one AlN layer having an interfacial AlOxNy region.

In some embodiments, the LESC coating comprising at least one Ag functional layer is utilized ‘as-deposited’, that is, without any intentional heat treatment or other forms of activation during or after the deposition. This is typically the case, for example, when the coating is deposited on a plastic substrate, and the resultant structure is used as a light-weight window insert.

In some embodiments, the coating is activated during the deposition, e.g., by being deposited on a heated substrate or by being exposed in situ to a source of intense energy, such as light, radio-frequency, radiative heat, or another form of radiation, or a combination thereof.

In some embodiments, the coating is activated after the deposition—either inline or offline—by being exposed to a source of convective or radiative heat energy, radio-frequency, intense light, or another source of radiation, or a combination thereof. This is also amenable where polymeric substrates are used; that is, appropriate activation methods are used where the thermal effects are appropriately controlled in relation to the transition temperature of the polymeric material.

In some embodiments, the activation is done during the glass heat tempering or high-temperature bending.

In some embodiments, the structure comprising the LESC coating is monolithic, wherein the coating is exposed to the environment.

In some embodiments, the structure comprising the coating is laminated, wherein the substrate with the coating on it is bonded to another pane by means of a thermoplastic bonding layer.

Examples of the embodiments are presented below. The disclosed examples are illustrative and should not be considered as restrictive.

### Example 1

Example 1 is a LESC structure comprising a 1.5 mm thick PMMA substrate primed with a siloxane hard coating and a sputtered coating having an AlN/AlOxNy wetting bilayer and an AlOxNy/AlN top bilayer. The coating also comprises AR and color-control layers. The structure is characterized by the following values: U-factor=1.4; SHGC=0.66; Tvis=78%.

Transmitted and film-side reflected colors (CIELAB chromaticity space) of the structure are as follows: T(8°): a*=0.6, b*=3.9; R(8°): a*=−0.2, b*=−9.0. The structure was found to successfully pass the crosshatch adhesion test using an Elcometer 107 Cross Hatch Tester having 11 teeth with 1 mm spacing in accordance with standards ISO2409 and ASTM D3359 as well as abrasion tests according with standards ASTM F1319, ISO 105-X12, and ASTM D2486. A summary of selected tests and their results is presented in Table I.

TABLE I
A summary of selected optical, thermal, and mechanical
tests and their results referred to Embodiment 1.

| | | Change from | Test |
|---|---|---|---|
| Performance | Test | original value | Method(s) |
| Optical | Tvis | −0.20% | EN410 |
| | | | ISO9050 |
| | Haze | +0.25% | ASTM D1003 |
| | DE Color | +0.20 | ISO11341 |
| | | | ISO11664-4 |
| Thermal | Emissivity | +3.00% | NFRC 301 |
| | Damp heat | No cracking | IEC62108 |
| | T = 65° C., RH = 85% (2000 h) | | |
| | Thermal cycling, | No cracking | IEC62108 |
| | 500 cycles from −20 to +55° C. | | |
| | Accelerated thermal cycling, | No loss of performance | EN 1279-2 |
| | 3600 cycles from −18° C. to +53° C. | | |
| Mechanical | Adhesion | Pass | ISO2409 |
| | Crosscut and tape, GT 0 | | ASTM D3359-09 |
| | Elcometer crosshatch, 5B | | |
| | Haze change after abrasion, | +5.00% | TABER linear |
| | 500 g/250 cycles | | abrader |

### Example 2

Example 2 is similar to Example 1 but the substrate is a 3.0 mm thick PMMA, and a LESC sputtered coating has only one AlN wetting layer with an interfacial AlOxNy region created via exposing the surface of ALN to an oxygen-containing plasma. The coating additionally comprises AR and color-control layers. A NiCrOx blocker layer is disposed above the Ag functional layer. An AlN layer doped with hydrogen is disposed above the NiCrOx blocker layer.

### Example 3

Example 3 is similar to Example 1 but the substrate is a 3.2 mm thick soda-lime glass, and a LESC sputtered coating is deposited without the color-control layer. The structure is post-deposition heat treated at 630° C. for 10 minutes.

### Example 4

Example 4 is similar to Example 3 but the substrate is a 2.0 mm thick soda-lime glass, and a LESC sputtered coating is deposited with the color-control layer. The structure is post-deposition bent using gravitational bending at 630° C. The structure is then laminated to a second protecting glass pane, 2.0 mm thick, with the help of a 0.76 mm thick polyvinyl butyral thermoplastic bonding layer.

### REFERENCES

Patent Literature

| Publication | Priority | Publication | | |
|---|---|---|---|---|
| Number | Date | Date | Assignee | Title |
| U.S Pat. No. 5,737,885A | 1996 Mar. 29 | 1998 Apr. 14 | Eckhart | Secondary interior |
| | | | Albert | window |
| | | | Stoyke | |
| U.S Pat. No. 11,008,800B2 | 2018 May 29 | 2021 May 18 | Alpen High | Secondary |
| | | | Performance | window |
| | | | Products Inc | |
| RU2421419C2 | 2007 Jan. 5 | 2011 Jun. 20 | Pilkington | Thermally treated |
| | | | Group Ltd. | window glass with |
| | | | | coating |
| US20170240463A1 | 2014 Sep. 30 | 2017 Aug. 24 | Saint- | Substrate |
| | | | Gobain | provided with a |
| | | | Glass | stack having |
| | | | France | thermal properties |
| | | | | and a |
| | | | | substoichiometric |
| | | | | intermediate layer |
| U.S Pat. No. 9,708,215B2 | 2009 Mar. 9 | 2017 Jul. 18 | Saint | Substrate |
| | | | Gobain | provided with a |
| | | | Glass | multilayer coating |
| | | | France SAS | having thermal |
| | | | | properties, which |
| | | | | includes high- |
| | | | | refractive-index |
| | | | | layers |
| U.S Pat. No. 9,561,981B2 | 2014 Feb. 14 | 2017 Feb. 07 | AGC Glass | Glass panel |
| | | | Europe SA | comprising a solar |
| | | | | control layer |
| U.S Pat. No. 9,896,377B2 | 2013 May 30 | 2018 Feb. 20 | AGC Glass | Low-emissivity |
| | | | Europe | and anti-solar |
| | | | | glazing |
| US20030180547A1 | 2002 Feb. 11 | 2003 Sep. 25 | PPG | Solar control |
| | | | Industries | coating |
| | | | Ohio Inc | |
| CA3061105A | 2017 Apr. 17 | 2018 Oct. 25 | 3e Nano Inc | Energy control |
| | | | | coatings, |
| | | | | structures, |
| | | | | devices, and |
| | | | | methods of |
| | | | | fabrication thereof |
| U.S Pat. No. 4,900,633A | 1987 Mar. 26 | 1990 Feb. 13 | PPG | High performance |
| | | | Industries, | multilayer |
| | | | Inc. | coatings |
| U.S Pat. No. 10,358,384B2 | 2010 Mar. 29 | 2019 Jul. 23 | Vitro, S.A.B. | Solar control |
| | | | De C.V. | coatings with |
| | | | | discontinuous |
| | | | | metal layer |
| U.S Pat. No. 4,920,006A | 1987 Mar. 26 | 1990 Apr. 24 | PPG | Colored metal |
| | | | Industries, | alloy/oxynitride |
| | | | Inc. | coatings |
| WO2024074490A1 | 2022 Oct. 5 | 2024 Apr. 11 | Agc Glass | Coated glass |
| | | | Europe | substrate and |
| | | | | method for |
| | | | | making the same |
| U.S Pat. No. 9,598,311B2 | 2011 Feb. 17 | 2017 Mar. 21 | Pilkington | Heat treatable |
| | | | Group Ltd | coated glass pane |
| EP2173677B1 | 2022 Mar. 23 | 2007 Jun. 27 | Pilkington | Heat treatable |
| | | | Group Ltd | coated glass pane |
| GB2428251A | 2005 Jul. 9 | 2007 Jan. 24 | Pilkington | Multilayer solar |
| | | | Group Ltd | control glass |
| | | | | coating |
| WO2007018974A2 | 2005 Aug. 4 | 2007 Feb. 15 | Guardian | Broad band |
| | | | Industries | antireflection |
| | | | Corp. | coating and |
| | | | | method of making |
| | | | | same |
| DE102008007981A1 | 2008 Feb. 7 | 2009 Aug. 20 | Saint- | Thermally highly |
| | | | Gobain | loadable low-E- |
| | | | Sekurit | layer system for |
| | | | Deutschland | coating |
| | | | Gmbh & Co. | transparent flat |
| | | | | substrates such |
| | | | | as glass panes, |
| | | | | comprises two |
| | | | | silver functional |
| | | | | layers, zinc oxide |
| | | | | layers, metallic |
| | | | | nickel-chromium |
| | | | | blocker layers, |
| | | | | and dielectric |
| | | | | layers |

### Non-Patent Literature (NPL)

M. Ferrara, et al., AlN-Ag based low-emission sputtered coatings for high visible transmittance window, Surface & Coatings Technology 295, 2 (2016), http://dx.doi.org/10.1016/j.surfcoat.2015.12.015.
Y. Zou, et al., Enhanced adhesion strength of silver paste on AlN ceramic substrate via sintered nano-CuO, Ceramics International 47 (7), (2021) 9471, https://doi.org/10.1016/j.ceramint.2020.12.080.
W.-L. Jang, et al., Effect of thermal cycling on the adhesion strength of Ti/Ni/Ag films on AlN substrate, Thin Solid Films 519 (16) 5539 (2011), https://doi.org/10.1016/j.tsf.2011.02.052

Therefore what is claimed is:

1. A solar-control structure comprising:
a substrate;
a AlN wetting layer having an upper surface and a lower surface, said lower surface contacting said substrate or being spaced from said substrate by one or more intermediate layers, said AlN wetting layer having a thickness between about 10 and about 100 nm;
a silver functional layer having opposed top and bottom surfaces with the bottom surface contacting said upper surface of said wetting layer;
wherein a subsurface region within said AlN wetting layer, immediately adjacent to the bottom surface of said silver functional layer, has a subsurface region oxygen concentration elevated relative to an oxygen concentration within regions of said wetting layer that reside away from said upper surface of said AlN wetting layer, the subsurface region within said AlN wetting layer immediately adjacent to the bottom surface of said silver functional layer having a formula AlOxNy, said subsurface region containing AlOxNy has a thickness of at least 3 nm; and
wherein said solar-control structure is characterized by an integrated visible light transmittance of at least 25%, as defined by ISO9050.

2. The solar-control structure according to claim 1, wherein said subsurface elevated oxygen concentration being representative of the ‘x’ in the AlOxNy formula being at least 0.01.

3. The solar-control structure according to claim 1, wherein said subsurface region containing AlOxNy region has a thickness from about 3 nm to about 7 nm.

4. The solar-control structure according to any one of claim 1, wherein said AlN wetting layer has a thickness between about 20 and about 50 nm.

5. The solar-control structure according to claim 1, wherein said silver functional layer has a thickness in a range from about 5 nm to about 25 nm.

6. The solar-control structure according to claim 1, further comprising a AlN layer, having an upper surface and a lower surface, with the lower surface being on the top surface of the silver functional layer, and wherein a subsurface region within said top AlN layer, immediately adjacent to the top surface of said silver functional layer, has a subsurface region oxygen concentration elevated relative to an oxygen concentration within regions of said wetting layer that reside away from said lower surface of said top AlN layer having a formula AlOxNy.

7. The solar-control structure according to claim 6, further comprising a protection layer on the upper surface of the AlN layer.

8. The solar-control structure according to claim 7, wherein the protection layer is anyone of SiO₂, SiOxNy, ZrSiO₄, TiO₂, or ZrTiO₄.

9. The solar-control structure according to claim 7, wherein the protection layer has a thickness between about 10 and about 60 nm.

10. The solar-control structure according to claim 7, wherein the protection layer has a thickness between about 15 nm and about 30 nm.

11. The solar-control structure according to claim 7, further comprising a color-control layer between the upper surface of the AlN layer and the protection layer.

12. The solar-control structure according to claim 11, wherein the color-control layer has an index of refraction in a range from about 1.6 to about 2.8 at a wavelength of about 550 nm.

13. The solar-control structure according to claim 11, wherein said color-control layer comprises is anyone of ZnSnO₃, TiO₂, Nb₂O₅, ZrO₂, or TiZrO₄.

14. The solar-control structure according to claim 11, wherein the thickness of the color-control layer is between about 10 and about 80 nm.

15. The solar-control structure according to claim 11, wherein the thickness of the color-control layer is between about 30 and about 70 nm.

16. The solar-control structure according to claim 6, further comprising a blocker layer between the AlN layer and the silver functional layer.

17. The solar-control structure according to claim 1, further comprising an antireflection layer between the substrate and the AlN wetting layer.

18. The solar-control structure according to claim 17, wherein the antireflection layer is any one of TiO₂, Nb₂O₅, TiSiO₄ and SiOxNy, with ‘x’ ranging between about 0 and about 0.4 and ‘y’ is between about 0.6 and about 1, with each material having an index of refraction of at least 1.8 at about 550 nm, and a thickness between about 5 and about 50 nm.

19. The solar-control structure according to claim 18, wherein the antireflection layer thickness between about 10 and about 30 nm.

20. The solar-control structure according to claim 1, wherein an oxygen concentration in said regions of said wetting layer that reside outside said subsurface region of said AlN wetting layer is less than 0.01 atomic % (at. %).

21. The solar-control structure according to claim 1, wherein an oxygen concentration in said subsurface region within said AlN wetting layer immediately adjacent to the bottom surface of said silver functional layer has an oxygen concentration of 0.01 at. % or greater.

22. The solar-control structure according to claim 1, integrated with a window.

23. A glazing comprising a solar-control structure according to claim 1.
